(19) United States
(12) Patent Application Publication
(10) Pub. No.: US 2013/0202373 A1
(43) Pub. Date: Aug. 8, 2013

(54) DEFLECTION CORRECTION DEVICE FOR RAM

(71) Applicants: Takumi Hori, Takasago-shi (JP); Satoshi Furutate, Ritto-shi (JP); Hiroyuki Domaru, Ritto-shi (JP)

(72) Inventors: Takumi Hori, Takasago-shi (JP); Satoshi Furutate, Ritto-shi (JP); Hiroyuki Domaru, Ritto-shi (JP)

(73) Assignee: MITSUBISHI HEAVY INDUSTRIES, LTD., Tokyo (JP)

(21) Appl. No.: 13/387,996

(22) PCT Filed: Dec. 28, 2009
(86) PCT No.: PCT/JP2009/071754

§ 371 Date: Feb. 29, 2012

(51) Int. Cl. B23B 35/00

(52) U.S. Cl. CPC B23B 35/00
USPC 408/11

(57) ABSTRACT

It is intended to provide a machining tool provided with a ram, which has a simple structure and an inexpensive device cost, and is capable of correcting a deflection of a tip of a main shaft unit caused by extending the ram. A deflection correction device for a ram 1 in a machining tool which is provided with a saddle 13 moving vertically along a guide of a column 14 and the ram 1 housing a main shaft unit 15 and being fitted in the saddle 13 slidably in a horizontal direction. The device may include a plurality of hydrostatic bearings 2a via which the saddle 13 is supported by the column 14 in a longitudinal direction of the column 14, and a control unit 10 which controls a hydraulic pressure of the hydrostatic bearing 2a in accordance with a vertical displacement of the ram 1 to maintain a straightness of the ram 1 in a direction of a main shaft of the ram 1 so as to correct a misalignment of the main shaft unit 15 by an inclination of the saddle 13 caused by controlling the hydraulic pressure.

### TECHNICAL FIELD

The present invention relates to a deviation correction device for a ram in a machining tool provided with a saddle moving vertically along a guide of a column and a ram housing a main shaft unit and fit into the saddle slidably in a horizontal direction.

### BACKGROUND ART

A ram of a horizontal boring machine houses the main shaft unit and is fit into the saddle slidably in the horizontal direction. The ram is supported by the saddle moving vertically along the guide of the column in a cantilever state. Specifically, as shown in FIG. 11 illustrating the invention of Patent Literature 1, JP62-47125A, the saddle 13 moves vertically along the guide of the column 14.

In the saddle 13, the ram 1 housing the main shaft unit is fitted slidably in the horizontal direction.

The saddle 13, the ram 1 and other parts are connected to balance weights 20 and 21 by a hanger to balance the saddle 13, the ram 1 and other devices with the balance weights 20 and 21.

As described above, the ram of the horizontal boring machine is fitted in the saddle 13 slidably in the horizontal direction. With one side the ram being supported by the saddle 13 moving vertically along the guide of the column 14, when the ram 1 is retracted as shown in FIG. 12A, there is substantially no deflection of the ram 1. However, when the ram 1 is extended, the ram moves in a direction of an arrow W in a cantilever state, causing the ram 1 to bed from a centerline 1a to a deflection line 1b of FIG. 12B.

Patent Literature 2, JP2003-103434A proposes a solution to the above issue.

In Patent Literature 2, JP2003-103434A, a pair of ball screws are provided to support a main shaft head (saddle) movably in the vertical direction and the main shaft head supports the ram slidably in the horizontal direction. The ball screw on a front side in a direction of the ram movement is driven by a first servomotor and the other ball screw is driven by a second servomotor. When the ram extends forward to the front side, the ball screw on the front side is turned more compared to a main shaft movement command before correction to lift the main shaft, whereas the other ball screw is turned less to lower the rear side of the main shaft head, thereby maintaining a balance of the main shaft head horizontally.

In this manner, a guide surface of the ram is balanced horizontally in the above manner, preventing a tip of the main shaft head at the tip of the ram from being displaced.

According to Patent Literature 2, JP2003-103434A, there is no need for the balancing weights of the saddle, the ram and other devices. However, moving the saddle and the ram requires turning of the pair of the ball screws according to the main shaft movement data. Thus, the position control of the ram requires significant power and the devices for turning the ball screws, for setting the main shaft movement data or the like become expensive.

### CITATION LIST

### Patent Literature

### [Patent Literature 1]

JP62-047125A

### [Patent Literature 2]

JP2003-103434A

### SUMMARY OF INVENTION

### Technical Problem

In view of the above issues, it is an object of the present invention is to provide a machining tool provided with a ram, which has a simple structure and an inexpensive device cost, and is capable of correcting a deflection of a tip of a main shaft unit caused by extending the ram.

### Solution to Problem

In view of the above issues, a first aspect of the present invention is a deflection correction device for a ram in a machining tool which is provided with a saddle moving vertically along a guide of a column and the ram housing a main shaft unit and being fitted in the saddle slidably in a horizontal direction, the device including, but not limited to:

a plurality of hydrostatic bearings via which the saddle is supported by the column in a longitudinal direction of the column; and

a control unit which controls a hydraulic pressure of the hydrostatic bearing in accordance with a vertical displacement of the ram to maintain a straightness of the ram in a direction of a main shaft of the ram so as to correct a misalignment of the main shaft unit by an inclination of the saddle caused by controlling the hydraulic pressure.

In the first aspect of the present invention, it is preferable that the control unit controls a hydraulic pressure of one of the plurality of the hydrostatic bearings supporting the saddle in the longitudinal direction of the column so as to maintain the straightness of the ram in the direction of the main shaft of the ram, the one of the hydrostatic bearings being in an extending direction of the ram and below the main shaft of the main shaft unit.

In the first aspect of the present invention, it is also preferable that the control unit controls a hydraulic pressure of another of the hydrostatic bearings in addition to the one of the hydrostatic bearings which is arranged in the extending direction of the ram and below the main shaft of the main shaft unit so as to maintain the straightness of the ram in the direction of the main shaft of the ram, the another of the hydrostatic bearings being arranged symmetrically to the one of the hydrostatic bearings with respect to an intersection of the main shaft of the main shaft unit and a center line of the column that run at right angles to each other.

A second aspect of the present invention is a deflection correction device for a ram in a machining tool which is provided with a saddle moving vertically along a guide of a column and the ram housing a main shaft unit and being fitted in the saddle slidably in a horizontal direction, the device including, but not limited to:

a plurality of hydrostatic bearings via which the ram is supported by the saddle in a longitudinal direction of the ram; and

a control unit which controls a hydraulic pressure of the hydrostatic bearing in accordance with a vertical displacement of the ram to maintain a straightness of the ram in a direction of a main shaft of the ram so as to correct a misalignment of the main shaft unit by an inclination of the saddle caused by controlling the hydraulic pressure.

In the second aspect of the present invention, it is preferable that the control unit controls a hydraulic pressure of one of the plurality of the hydrostatic bearings supporting the ram to the saddle so as to maintain the straightness of the ram in the direction of the main shaft of the ram, the one of the hydrostatic bearings being arranged in an extending direction of the ram and below a main shaft of the main shaft unit.

In the second aspect of the present invention, it is also preferable that the control unit controls a hydraulic pressure of another of the hydrostatic bearings in addition to the one of the hydrostatic bearings which is arranged in the extending direction of the ram and below the main shaft of the main shaft unit so as to maintain the straightness of the ram in the direction of the main shaft of the ram, the another of the hydrostatic bearings being arranged symmetrically to the one of the hydrostatic bearings with respect to an intersection of the main shaft of the main shaft unit and a center line of the saddle that run at right angles to each other.

The above deflection correction device may further include a restricting device which regulates an amount of oil supplied to the hydrostatic bearing and a hydraulic pressure sensor which measures the hydraulic pressure of the oil supplied to each of the hydrostatic bearings and the control unit may control a restriction amount of the restricting device so that the hydraulic pressure becomes a target hydraulic pressure of the hydrostatic bearing based on a hydraulic pressure detected by the hydraulic pressure sensor.

Further, the above deflection correction device may further include a restricting device which regulates an amount of oil supplied to the hydrostatic bearing and the control unit may control a restriction amount of the restricting device so that the restriction amount of the restricting device becomes a target restriction amount which is calculated to achieve a target hydraulic pressure of the hydrostatic bearing.

### Advantageous Effects of Invention

In the present invention, according to the correction process performed by the control unit, the saddle is supported by the column in a longitudinal direction of the column via a plurality of hydrostatic bearings and a hydraulic pressure of the hydrostatic bearing is controlled by the control unit in accordance with a vertical displacement of the ram to maintain a straightness of the ram in a direction of a main shaft of the ram so as to correct a misalignment of the main shaft unit by an inclination of the saddle caused by controlling the hydraulic pressure.

Further, the ram is supported by the saddle in a longitudinal direction of the ram via a plurality of hydrostatic bearings and a hydraulic pressure of the hydrostatic bearing is controlled by the control unit in accordance with a vertical displacement of the ram to maintain a straightness of the ram in a direction of a main shaft of the ram so as to correct a misalignment of the main shaft unit by an inclination of the saddle caused by controlling the hydraulic pressure.

Therefore, according to the present invention, it is possible to maintain the straightness of the ram in the direction of the main shaft by the above correction method, thereby achieving a high machining accuracy.

Further, by adjusting the hydraulic pressure of the plurality of the hydrostatic bearings, the balance weights are no longer needed, as was the case of the related art. It is now possible to achieve the high machining accuracy by the device with a simple structure and an inexpensive device cost.

Among the plurality of the hydrostatic bearings supporting the saddle in the longitudinal direction of the column, a hydraulic pressure of the one of the hydrostatic bearings which is arranged in the extending direction of the ram and below the main shaft of the main shaft unit is controlled by the control unit so as to maintain the straightness of the ram in the direction of the main shaft of the ram. Therefore, by inclination of the saddle caused by controlling the hydraulic pressure, the straightness of the ram in the direction of the main shaft can be maintained.

Among the plurality of the hydrostatic bearings supporting the ram to the saddle, a hydraulic pressure of the one of the hydrostatic bearings which is arranged in an extending direction of the ram and below a main shaft of the main shaft unit is controlled by the control unit so as to maintain the straightness of the ram in the direction of the main shaft of the ram. Therefore, by inclining the ram in response to controlling of the hydraulic pressure, the straightness of the ram in the direction of the main shaft can be maintained.

Among the plurality of the hydrostatic bearings supporting the saddle in the longitudinal direction of the column, a hydraulic pressure of another of the hydrostatic bearings in addition to the one of the hydrostatic bearings is controlled by the control unit so as to maintain the straightness of the ram in the direction of the main shaft of the ram. The another of the hydrostatic bearings being arranged symmetrically to the one of the hydrostatic bearings with respect to an intersection of the main shaft of the main shaft unit and a center line of the column that run at right angles to each other. For instance, it is possible to correct the misalignment of the main shaft unit by the inclination of the saddle in response to controlling of the hydraulic pressures of a pair of the hydrostatic bearings 2a and 3a as shown in FIG. 2. The misalignment of the main shaft unit can be corrected more significantly than the case of using one hydrostatic bearing to correct the misalignment. This allows for a greater extension amount of the rum.

Further, the load capability of the hydrostatic bearing supporting the tip of the ram increases and thus, it is possible to withstand the weight increase of the ram such as addition of attachments.

In a similar manner, among the plurality of the hydrostatic bearings supporting the ram to the saddle, a hydraulic pressure of another of the hydrostatic bearings is controlled by the control unit in addition to the one of the hydrostatic bearings which is arranged in the extending direction of the ram and below the main shaft of the main shaft unit so as to maintain the straightness of the ram in the direction of the main shaft of the ram. The another of the hydrostatic bearings is arranged symmetrically to the one of the hydrostatic bearings with respect to an intersection of the main shaft of the main shaft unit and a center line of the saddle that run at right angles to each other. Specifically, the misalignment of the main shaft unit is corrected by the inclination of the ram in response to controlling of the hydraulic pressures of a pair of the hydrostatic bearings. The misalignment of the main shaft unit can be corrected more significantly than the case of using one hydrostatic bearing to correct the misalignment. This allows for a greater extension amount of the rum.

Further, the load capability of the hydrostatic bearing supporting the tip of the ram increases and thus, it is possible to withstand the weight increase of the ram such as addition of attachments.

The above deflection correction device is also provided with a restricting device which regulates an amount of oil supplied to the hydrostatic bearing and a hydraulic pressure sensor which measures the hydraulic pressure of the oil supplied to each of the hydrostatic bearings and the control unit controls a restriction amount of the restricting device so that the hydraulic pressure becomes a target hydraulic pressure of the hydrostatic bearing based on a hydraulic pressure detected by the hydraulic pressure sensor. Therefore, the misalignment of the main shaft unit caused by the deflection of the ram is corrected by performing the feedback control of the measured pressure of each hydrostatic bearing detected by the hydraulic pressure sensor. As a result, the pressure of the hydrostatic bearing can be kept at the appropriate value with high precision.

Alternatively, the above deflection correction device is also provided with a restricting device which regulates an amount of oil supplied to the hydrostatic bearing and the restriction amount of the restricting device is controlled so that the restriction amount of the restricting device becomes a target restriction amount which is calculated to achieve a target hydraulic pressure of the hydrostatic bearing. Therefore, it is also possible to provide no hydraulic pressure sensor.

### BRIEF DESCRIPTION OF DRAWINGS

FIG. 1 FIG. 1A and FIG. 1B show structures of a combined unit of a column, a saddle and a ram in relation to a first embodiment.

FIG. 1 shows a structure of the combined unit of the column, the saddle and the ram in relation to a second embodiment.

FIG. 3 shows a structure of the combined unit of the column, the saddle and the ram in relation to a third embodiment.

FIG. 4 shows a structure of the combined unit of the column, the saddle and the ram in relation to a fourth embodiment.

FIG. 5 shows a structure of the combined unit of the column, the saddle and the ram in relation to a fifth embodiment.

FIG. 6 is a flow chart of a control unit for correcting a position of a main shaft unit by an inclination of the saddle caused by increasing the hydraulic pressure in relation to the first embodiment.

FIG. 7 is a flow chart of the control unit for correcting the position of the main shaft unit by the inclination of the saddle caused by increasing the hydraulic pressure in relation to the second embodiment.

FIG. 8 is a flow chart of the control unit for correcting the position of the main shaft unit by an inclination of the ram caused by increasing the hydraulic pressure in relation to the third embodiment.

FIG. 9 is a flow chart of the control unit for correcting the position of the main shaft unit by the inclination of the ram caused by increasing the hydraulic pressure in relation to the fourth embodiment.

FIG. 10 is a flow chart of the control unit for correcting the position of the main shaft unit by the inclination of the ram caused by increasing the hydraulic pressure in relation to the fifth embodiment.

FIG. 11 is a schematic perspective view of a horizontal boring tool of related art.

FIG. 12 shows an engagement of the ram and the saddle.

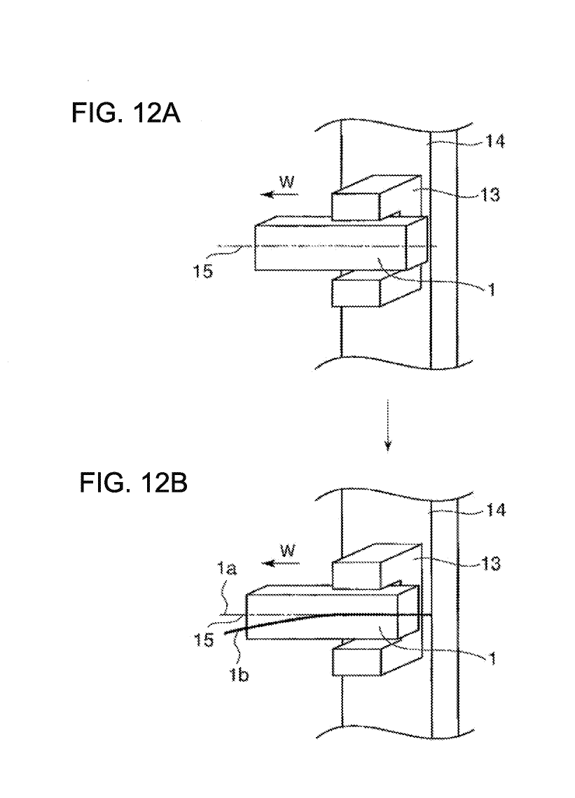

### DESCRIPTION OF EMBODIMENTS

Embodiments of the present invention will now be described in detail with reference to the accompanying drawings. It is intended, however, that unless particularly specified, dimensions, materials, shape, its relative positions and the like shall be interpreted as illustrative only and not limitative of the scope of the present invention.

### First Embodiment

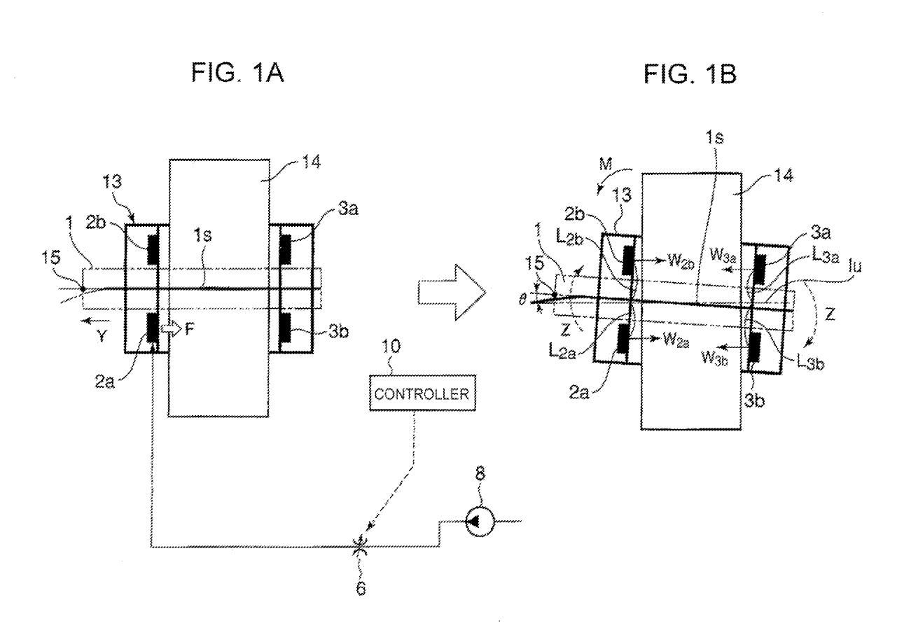

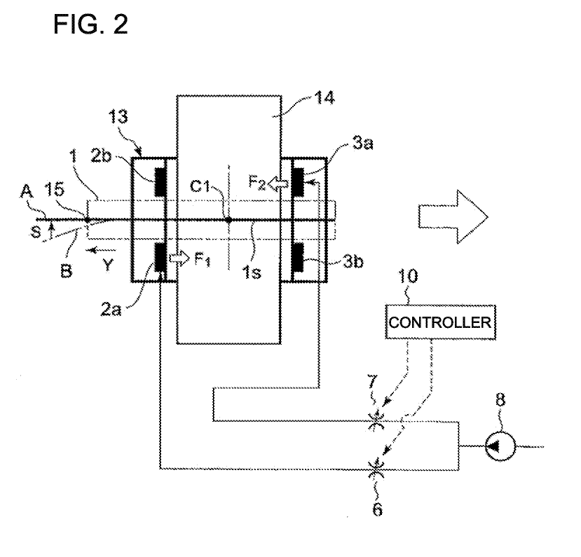

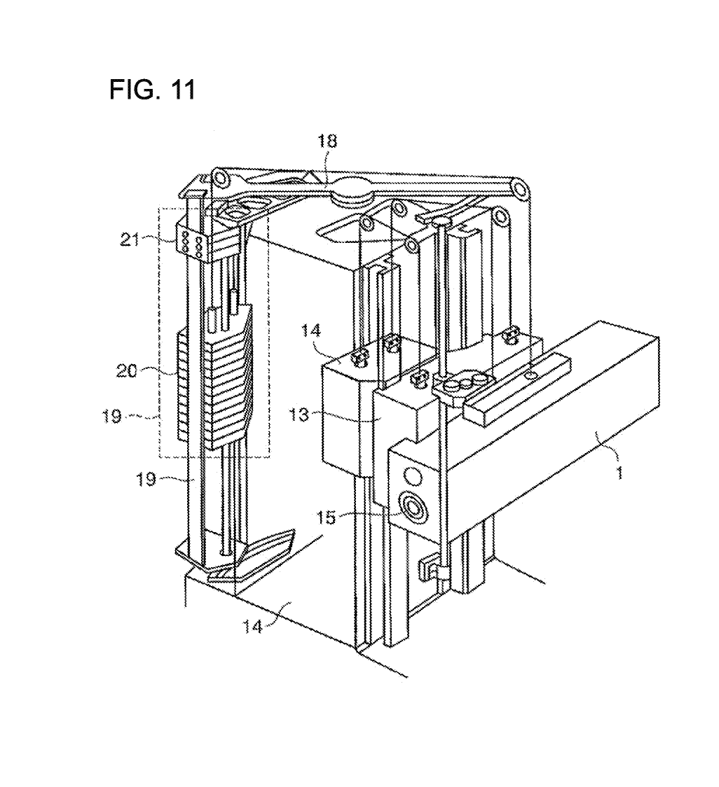

FIG. 1A and FIG. 1B show structures of a combined unit of a column, a saddle and a ram in relation to a first embodiment. The rest of the structure is similar to the structure shown in FIG. 11 except for the balance weights 21 and 22 (the structure with the part 19 in a dotted area removed from FIG. 11).

FIG. 1A and FIG. 1B show a column 14, a saddle 13 moving vertically along a guide of the column 14 and a ram 1 housing a main shaft unit 15 and being slidably fit in the saddle 13 in a horizontal direction.

The saddle 13 is supported at both sides by four hydrostatic bearings, two hydrostatic bearings 2a and 2b being arranged on a front side in a extending direction of the ram 1 and two hydrostatic bearings 3a and 3b being arranged on a root side of the ram 1.

A hydraulic pump 8 supplies the oil to the hydrostatic bearing 2a via a variable restricting device 6. A controller 10 controls a restriction amount of the restricting device 6. Among the hydrostatic bearings 2a, 2b, 3a and 3b supporting the saddle 13 in the longitudinal direction of the column 14, the hydrostatic bearing 2a is arranged in an extending direction of the ram 1 and below the main shaft of the main shaft unit 15. The hydraulic pressure of the hydrostatic bearing 2a is controlled.

From a stop state (or an almost-stop state) as shown in FIG. 1A to an operation state as shown in FIG. 1B, the ram 1 moves in a direction of an arrow Y. As shown in FIG. 1B, the ram 1 supported by the saddle 13 at one side, moves leftward from the saddle 13, increasing a projection amount from a support position.

At the same time, the controller 10 increases a pressure of the hydrostatic bearing 2 by regulating the restriction amount of the variable restricting device 6 and the saddle is lifted in a direction of an arrow Z of FIG. 1B by means of the hydrostatic bearing 2a.

By this, the saddle 13 inclines, thereby lifting a side of the ram 1, which is on the main shaft unit side 15 in a direction of an arrow Z of FIG. 1B. A line 1u shown in FIG. 1B indicates a horizontal line.

In this manner, a straightness of the ram 1 in a direction of the main shaft unit 15 is maintained.

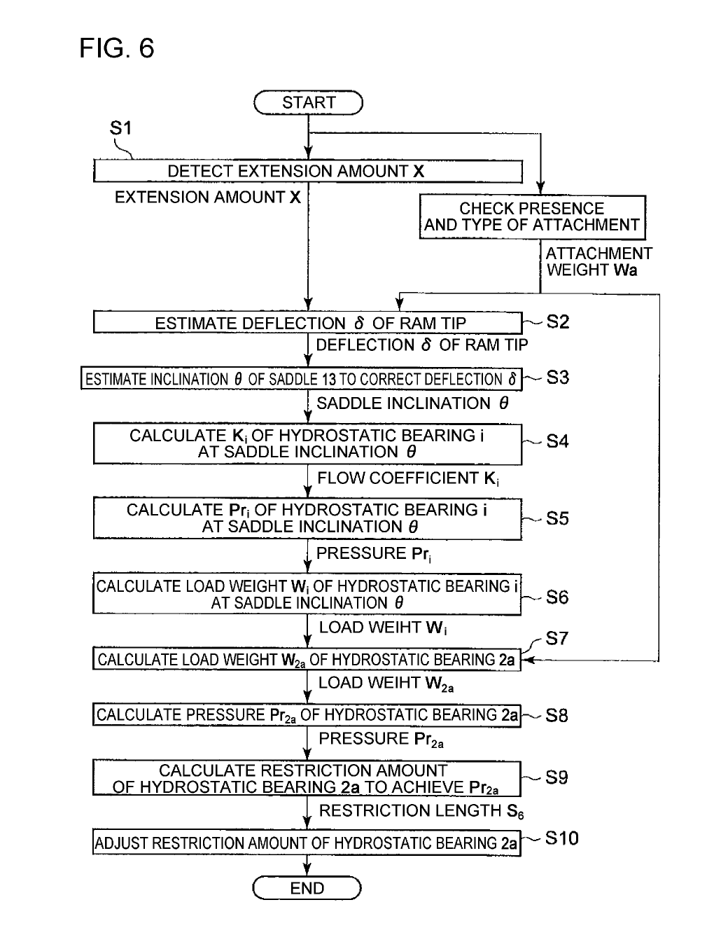

In order to maintain the straightness in the direction of the main shaft is of the ram 1, the controller 10 performs such control to increase the hydraulic pressure Pr₂ₐ of the hydrostatic bearing 2a in accordance with a vertical displacement of the ram 1, i.e. a deflection δ, thereby correcting the deflection δ by the inclination of the saddle caused by the increased hydraulic pressure Pr₂ₐ as shown in FIG. 6.

FIG. 6 is a flow chart of a control unit for correcting a position of the main shaft unit by the inclination of the saddle caused by increasing the hydraulic pressure.

In FIG. 6, in a step S1, an extending amount X of the ram 1, and based on the detected value, the following correction is performed.

In a step S2, the amount of deflection, δ is estimated from a formula (1).

δ=(WaX³/3EI)+(wX⁴/8EI) (1)

where Wa is a weight of an attachment, w is a uniformly distributed load, E is a longitudinal elastic modulus (self-weight) and I is a second moment of area of the ram 1.

In order to correct the amount of deflection δ, in a step S3, an angle θ of the upward inclination of the ram 1 is estimated from a formula (2).

θ=tan⁻¹(y/x) (2)

where y and x are angles of inclination.

In a step S4, a flow coefficient Kᵢ of the hydrostatic bearing i is estimated.

In a step S5, a pressure Prᵢ of the hydrostatic bearing i (the hydrostatic bearings 2b, 3a and 3b excluding the controlled hydrostatic bearing 2a) at the inclination angle θ, is obtained from a formula (3).

Prᵢ=(1/(1+Kᵢ/Kcᵢ))·Psᵢ (3)

where Kcᵢ is a flow coefficient of a variable restricting device i and Psᵢ is a supply pressure of the hydrostatic bearing i.

In a step S6, a load weight Wᵢ of the hydrostatic bearing i at the inclination angle θ, is obtained from a formula (4).

Wᵢ=Aᵢ·Prᵢ (4)

where Aᵢ is an effective area of the hydrostatic bearing i.

In a step S7, a load weight W₂ₐ of the hydrostatic bearing 2a is obtained. The symbols that are not explained herein are shown in FIG. 1B.

M+W_{3b}L_{3b}+W_{2b}L_{2b}=W₂ₐL₂ₐ+W₃ₐL₃ₐ (5)

where M is a rotation moment acting to turn the saddle by self-weights of the ram, the attachment, and the saddle.

In a step S8, a pressure Pr₂ₐ of the hydrostatic bearing 2a is obtained from a formula (6).

Pr₂ₐ==W₂ₐ/A₂ₐ (6)

In steps S9 and S10, a flow coefficient Kc₂ₐ of the variable restricting device 6 to achieve the pressure Pr₂ₐ, is obtained, and the restriction amount of the variable restricting device 6 is adjusted to a restriction length S₆ to achieve the flow coefficient Kc₂ₐ. The restriction length is an adjustment amount of restriction of the restricting device 6.

In order to achieve the obtained hydraulic pressure of the hydrostatic bearing, the restriction amount is controlled in accordance with the flow coefficient. Thus, the control configuration can be simplified without a hydraulic pressure sensor.

According to the above correction process by the controller 10, the misalignment of the main shaft unit 15 can be corrected by an inclination θ of the saddle 13 caused by increasing the hydraulic pressure Pr₂ₐ in accordance with the vertical displacement of the ram 1, i.e. the deflection δ, so as to maintain the straightness of the ram 1 in the direction of the main shaft is.

According to the first embodiment, it is possible to maintain the straightness of the rain 1 in the direction of the main shaft is by the above correction method, thereby achieving a high machining accuracy.

Further, by adjusting the hydraulic pressure of the hydrostatic bearings and a state of the variable restricting device, unlike the case of the related art, the balance weights (the parts in the dotted area 19 of FIG. 11) are no longer needed. It is now possible to achieve the high machining accuracy by the device with a simple structure and an inexpensive device cost.

### Second Embodiment

A second embodiment of the present invention is explained in reference to FIG. 2.

The basic structure is the same as that of the first embodiment. The saddle 13 is supported at both sides by four hydrostatic bearings, two hydrostatic bearings 2a and 2b being arranged on the front side in the extending direction of the ram 1 and two hydrostatic bearings 3a and 3b being arranged on the root side of the ram 1.

The hydraulic pump 8 supplies the oil to the hydrostatic bearing 2a via the variable restricting device 6 and to the hydrostatic bearing 3a via a variable restricting device 7. The controller 10 controls the restriction amount of the restricting device 6 and a restriction amount of the restricting device 7.

Among the hydrostatic bearings 2a, 2b, 3a and 3b supporting the saddle 13 in the longitudinal direction of the column 14, the hydrostatic bearing 2a is arranged in the extending direction of the ram 1 and below the main shaft of the main shaft unit 15. The hydraulic pressure of the hydrostatic bearing 2a is controlled and the hydrostatic bearing 3a is arranged symmetrically to the hydrostatic bearing 2a with respect to an intersection C1 of the main shaft of the main shaft unit 15 and a center line of the column 14 that run at right angles to each other. The controller 10 controls the hydraulic pressures of the hydrostatic bearings 2a and 3a.

From a stop state (or an almost-stop state) as shown in FIG. 2 to an operation state, the ram 1 moves in the direction of an arrow Y and the ram 1 supported by the saddle 13 at one side moves leftward from the saddle 13, causing a center line A to deflect to a center line B.

Meanwhile, the controller 10 regulates the restriction amount of the variable restricting device 6 to increases the pressure of the hydrostatic bearing 2a and also regulates the restriction amount of the variable restricting device 7 to increase the pressure of the hydrostatic bearing 3a.

Then, the saddle 13 is lifted in a direction of an arrow F of FIG. 2 by means of the hydrostatic bearing 2a on the front side in the extending direction of the ram 1. At the same time, the saddle is lowered in a direction of an arrow F2 of FIG. 2 by means of the hydrostatic bearing 3a on a side opposite to the front side.

By this, a position of a tip of the ram 1 changes onto a center axis of the ram 1 in a non-deflection state as indicated by an arrow S in FIG. 2, thereby maintaining the straightness of the ram 1 in the direction of the main shaft unit 15.

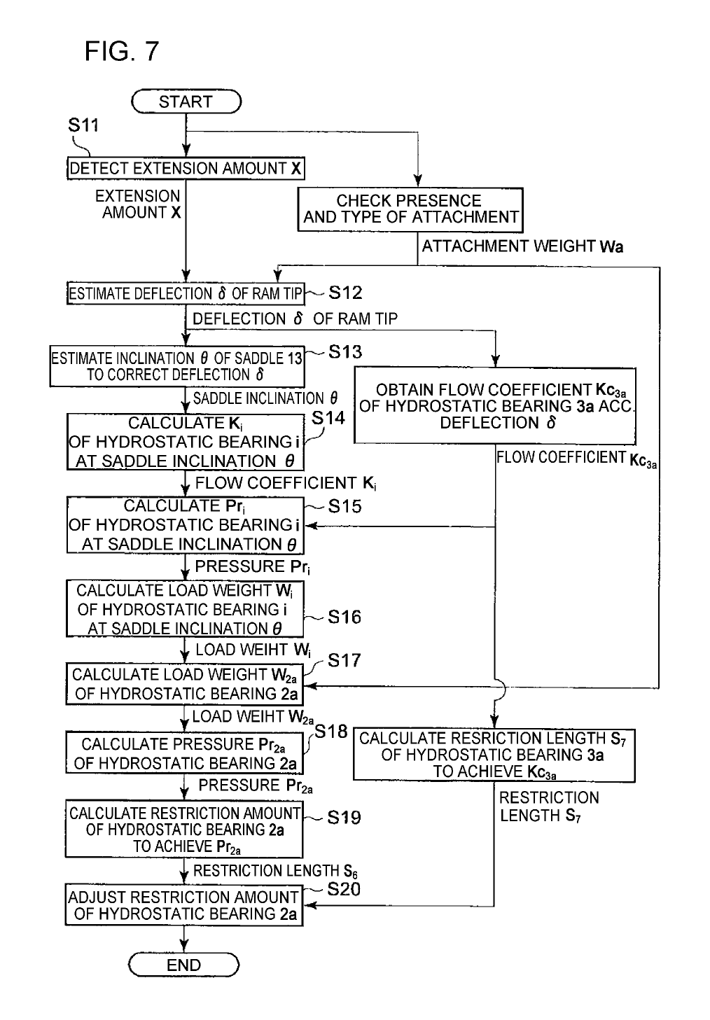

In order to maintain the straightness of the saddle 13 in the direction of the main shaft 1s, the controller 10 performs the control to increase the hydraulic pressures Pr₂ₐ and Pᵣ₃ₐ of the hydrostatic bearings 2a and 3a in accordance with a vertical displacement of the saddle 13, i.e. a deflection δ, thereby correcting the a misalignment of the main shaft unit 15 by the inclination angle θ of the saddle 13 caused by the increased hydraulic pressures Pr₂ₐ and Pr₃ₐ as shown in FIG. 7.

FIG. 7 is a flow chart of the control unit for correcting the position of the main shaft unit according to the second embodiment.

In FIG. 7, a flow coefficient Kc₃ₐ of the variable restricting device 7 of the hydrostatic bearing 3a is obtained from a database obtained beforehand in accordance with the amount of deflection δ of the tip of the saddle 13 calculated in a step S12.

The flow coefficient Kc₃ₐ of the variable restricting device 7 is used to calculate Prᵢ in a step S15 and also to calculate a restriction length S₇ of the restriction amount in a step S20.

The rest of the process is substantially the same as that of the first embodiment.

According to the correction method performed by the controller 10, it is possible to maintain the straightness of the saddle 13 in the direction of the main shaft is by means of the hydrostatic bearings 2a and 3a. The misalignment of the main shaft unit 15 caused by the deflection δ of the saddle 13 can be corrected more significantly than the first embodiment. This allows for a greater extension amount of the rum 1.

Further, the load capability of the hydrostatic bearing supporting the tip of the ram 1 increases and thus, it is possible to withstand the weight increase of the ram 1 such as addition of attachments.

### Third Embodiment

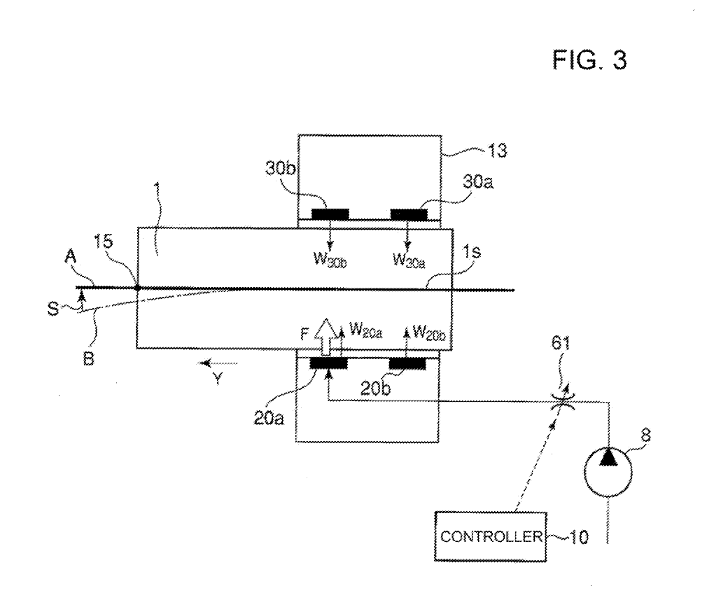

FIG. 3 shows a structure of the combined unit of the column, the saddle and the ram in relation to a third embodiment.

FIG. 3 shows the saddle 13 moving vertically along the guide of the column 14 (see FIG. 11) and the ram 1 housing the main shaft unit 15 and being slidably fit in the saddle 13 in a horizontal direction.

The ram 1 is supported by four hydrostatic bearings at upper and lower sides in a longitudinal direction of the ram 1. A pair of hydrostatic bearings 20a and 20b are arranged on the lower side and another pair of hydrostatic bearings 30a and 30b are arranged on the upper side.

The hydraulic pump 8 supplies the oil to the hydrostatic bearing 20a via a variable restricting device 61. The controller 10 controls a restriction amount of the restricting device 61. Among the hydrostatic bearings 20a, 20b, 30a and 30b supporting the ram 1 to the saddle 13, the hydrostatic bearing 20a is arranged in the extending direction of the ram 1 and below the main shaft of the main shaft unit 15. The hydraulic pressure of the hydrostatic bearing 2a is controlled.

From a stop state (or an almost-stop state) as shown in FIG. 3 to an operation state, the ram 1 moves in the direction of an arrow Y and the ram 1 supported by the saddle 13 at one side moves leftward from the saddle 13, causing a center line A to deflect to a center line B.

Meanwhile, the controller 10 regulates the restriction amount of the variable restricting device 61 to increases the pressure of the hydrostatic bearing 20a. Thus, a side of the ram 1 which is on the side of the main shaft unit 15, is lifted in a direction of an arrow F of FIG. 3 by means of the hydrostatic bearing 20a.

By this, a position of a tip of the ram 1 changes onto the center axis of the ram 1 in a non-deflection state as indicated by an arrow S in FIG. 3, thereby maintaining the straightness of the ram 1 in the direction of the main shaft unit 15.

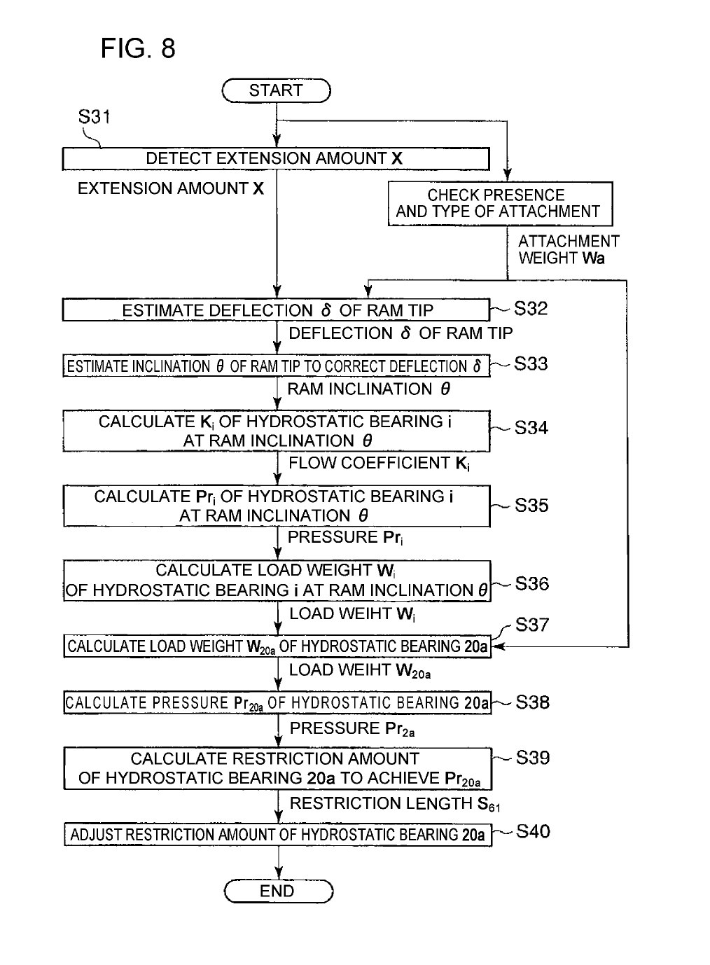

In order to maintain the straightness of the ram 1 in the direction of the main shaft 1s, the controller 10 performs a control to increase the hydraulic pressure Pr₂₀ₐ of the hydrostatic bearing 20a in accordance with a vertical displacement of the ram 1, i.e. a deflection δ, thereby correcting a misalignment of the main shaft unit 15 by the inclination of the ram 1 caused by the increased hydraulic pressure Pr₂₀ₐ as shown in FIG. 8.

In a step S37 of FIG. 8, a load weight W₂₀ₐ of the hydrostatic bearing 20a is obtained from a formula (5).

W₂₀ₐ=W+W_{30b}+W₃₀ₐ−W_{20b} (5)

where W is a weight of the ram 1 and the attachment. The symbols that are not explained herein are already described in FIG. 3.

The rest of the structure is substantially the same as the first embodiment.

According to the correction method performed by the controller 10, it is possible to maintain the straightness of the ram 1 in the direction of the main shaft 1s. The misalignment of the main shaft unit 15 can be corrected by increasing the hydraulic pressure Pr₂₀ₐ of the hydrostatic bearing 20a in accordance with the vertical displacement of the ram 1, i.e. the deflection δ.

### Fourth Embodiment

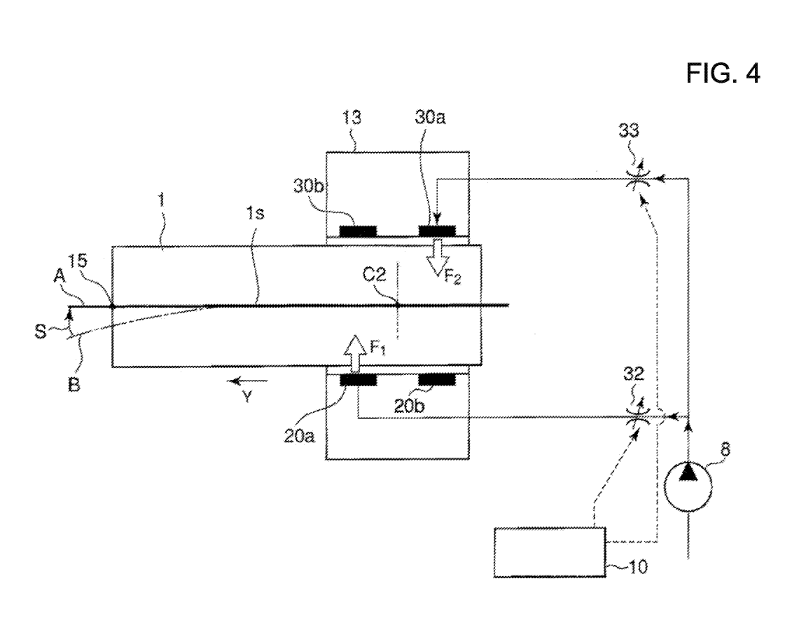

FIG. 4 shows a structure of the combined unit of the column, the saddle and the ram in relation to a fourth embodiment.

FIG. 4 shows the saddle 13 moving vertically along the guide of the column 14 (see FIG. 11) and the ram 1 housing the main shaft unit 15 and being slidably fit in the saddle 13 in the horizontal direction.

The ram 1 is supported by four hydrostatic bearings at upper and lower sides in the longitudinal direction of the ram 1. Two hydrostatic bearings 20a and 20b are arranged on the lower side and two hydrostatic bearings 30a and 30b are arranged on the upper side.

The hydraulic pump 8 supplies the oil to the hydrostatic bearing 20a via a variable restricting device 32 and to the hydrostatic bearing 30a via a variable restricting device 33. The controller 10 controls a restriction amount of the restricting device 32 and a restriction amount of the restricting device 33. Among the hydrostatic bearings 20a, 20b, 30a and 30b supporting the ram 1 to the saddle 13, the hydrostatic bearing 20a is arranged in the extending direction of the ram 1 and below the main shaft of the main shaft unit 15 and the hydrostatic bearing 30a is arranged symmetrically to the hydrostatic bearing 20a with respect to an intersection C2 of the main shaft of the main shaft unit 15 and a center line of the saddle 13 that run at right angles to each other. The controller 10 controls the hydraulic pressures of the hydrostatic bearings 20a and 30a

From a stop state (or an almost-stop state) as shown in FIG. 4 to an operation state, the ram 1 moves in the direction of an arrow Y and the ram 1 supported by the saddle 13 at one side moves leftward from the saddle 13, causing a center line A to deflect to a center line B.

Meanwhile, the controller 10 regulates the restriction amount of the variable restricting device 32 to increases the pressure of the hydrostatic bearing 20a and also regulates the restriction amount of the variable restricting device 33 to increase the pressure of the hydrostatic bearing 30a.

Therefore, a side of the ram 1, which is on the main shaft unit side 15, is lifted by means of the hydrostatic bearing 20a in a direction of an arrow F1 of FIG. 4 and simultaneously the ram 1 is pushed downward in a direction of an arrow F2 by means of the hydrostatic bearing 30a which is on the side opposite to the extending direction.

By this, a position of a tip of the ram 1 changes onto a center axis of the ram 1 in a non-deflection state as indicated by an arrow S in FIG. 3, thereby maintaining the straightness of the ram 1 in the direction of the main shaft unit 15.

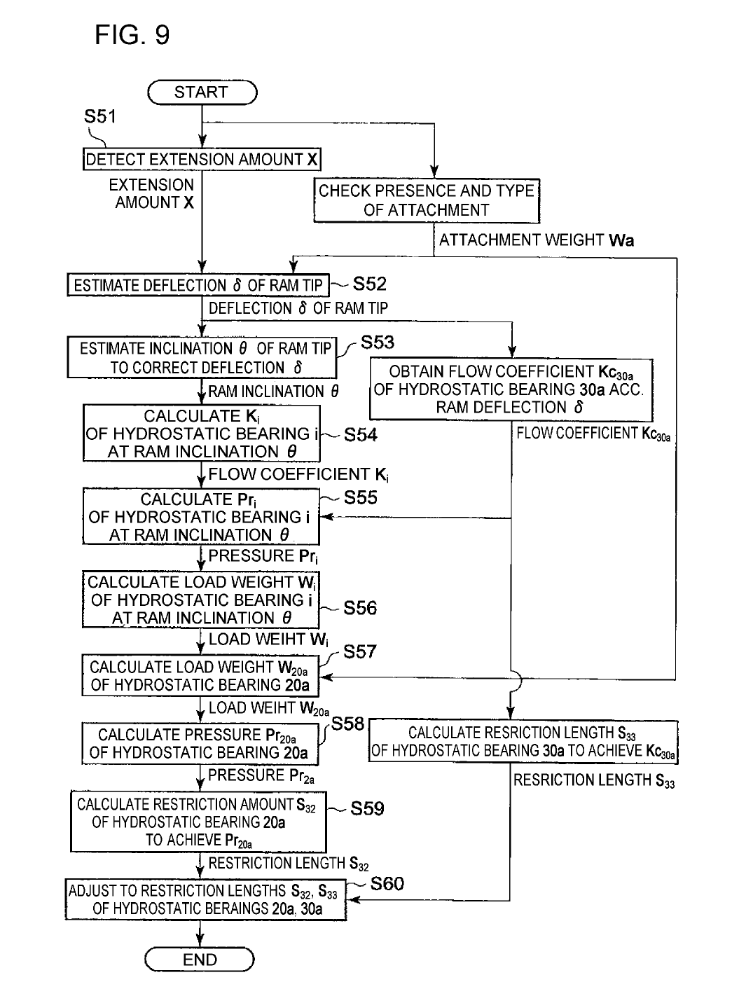

In order to maintain the straightness of the ram 1 in the direction of the main shaft 1s, the controller 10 performs a control to increase the hydraulic pressures Pr₂₀ₐ and Pr₃₀ₐ of the hydrostatic bearings 20a and 30a in accordance with a vertical displacement of the ram 1, i.e. the deflection δ, thereby correcting the a misalignment of the main shaft unit 15 by the inclination angle θ of the ram 1 caused by the increased hydraulic pressures Pr₂₀ₐ and Pr₃₀ₐ as shown in FIG. 9.

FIG. 9 is a flow chart of a control unit for correcting a position of the main shaft unit.

In FIG. 9, a flow coefficient Kc₃₀ₐ of the variable restricting device 33 of the hydrostatic bearing 30a is calculated from a database obtained beforehand in accordance with the amount of deflection δ of the tip of the ram 1 calculated in a step S52.

The flow coefficient Kc₃₀ₐ of the variable restricting device 33 is used in the formula for the pressure Prᵢ in a step S55 and also to calculate the adjustment amount of restriction S₃₃ of the restriction amount in a step S60. The rest of the process is substantially the same as that of the third embodiment.

According to the correction method performed by the controller 10, it is possible to maintain the straightness of the ram 1 in the direction of the main shaft is by means of the hydrostatic bearings 20a and 30a. The misalignment of the main shaft unit 15 caused by the deflection δ of the ram 1 can be corrected more significantly than the third embodiment. This allows for a greater extension amount of the rum 1.

Further, the load capability of the hydrostatic bearing supporting the tip of the ram 1 increases and thus, it is possible to withstand the weight increase of the ram 1 such as addition of attachments.

### Fifth Embodiment

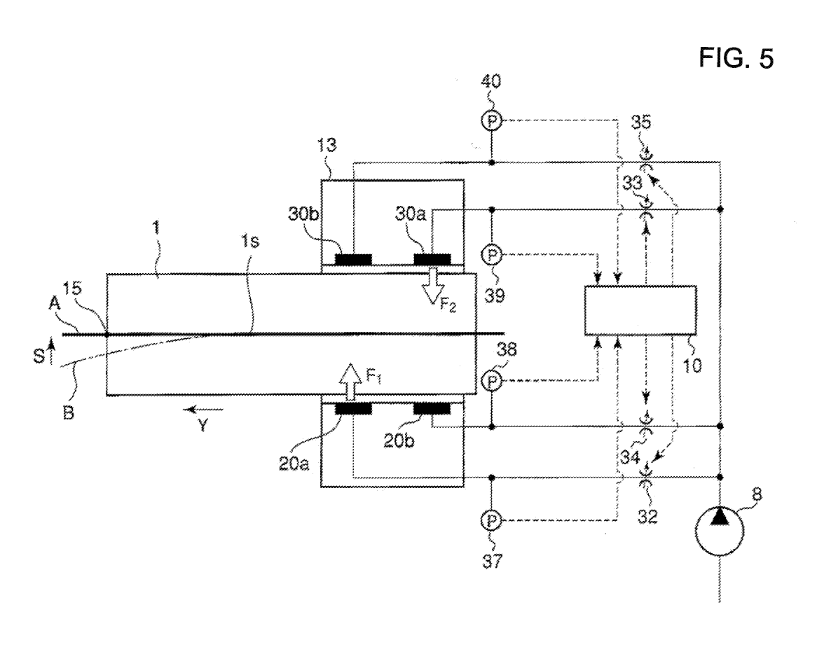

FIG. 5 shows a structure of the combined unit of the column, the saddle and the ram in relation to a fifth embodiment.

FIG. 5 shows the saddle 13 moving vertically along the guide of the column 14 (see FIG. 11) and the ram 1 housing the main shaft unit 15 and being slidably fit in the saddle 13 in the horizontal direction.

The ram 1 is supported by four hydrostatic bearings at upper and lower sides in a longitudinal direction of the ram 1. Two hydrostatic bearings 20a and 20b are arranged on the lower side and two hydrostatic bearings 30a and 30b are arranged on the upper side.

The hydraulic pump 8 supplies the oil to the hydrostatic bearing 20a via a variable restricting device 32 and to the hydrostatic bearing 30a via the variable restricting device 33. Further, the hydraulic pump 8 is connected to the hydrostatic bearing 20b via the variable restricting device 34 and to the hydrostatic bearing 30b via the variable restricting device 35.

The controller 10 controls the restriction amounts of the variable restricting devices 32 and 33. Further, the controller 10 controls the restriction amounts of the variable restricting devices 34 and 35.

In the oil path of each of the hydrostatic bearings 20a, 20b, 30a and 30b, a hydraulic pressure sensor 37, 38, 39, 40 is provided to measure the hydraulic pressure of the oil in each oil path. The measured pressure is inputted from the hydraulic pressure sensor 37, 38, 39, 40 to the controller 10.

From a stop state (or an almost-stop state) as shown in FIG. 5 to an operation state, the ram 1 moves in the direction of an arrow Y and the ram 1 supported by the saddle 13 at one side moves leftward from the saddle 13, causing a center line A to deflect to a center line B.

Meanwhile, the controller 10 regulates the restriction amount of the variable restricting device 34 to increases the pressure of the hydrostatic bearing 20a and also regulates the restriction amount of the variable restricting device 35 to increase the pressure of each of the hydrostatic bearings 20a, 20b, 30a and 30b at an appropriate value based on the measured pressure inputted from the

The controller 10 adjusts the pressure of the hydrostatic bearing 20a, 20b, 30a, 30b based on the measured pressure inputted from the hydraulic pressure sensor 37, 38, 39, 40. Specifically, based on the measured pressure inputted from the hydraulic pressure sensor 37, 38, 39, 40, the pressure of the hydrostatic bearings 20a and 20b and the pressure of the hydrostatic bearings 30a and 30b can be kept at the prescribed appropriate value.

Therefore, a side of the ram 1, which is on the main shaft unit side 15, is lifted by means of the hydrostatic bearing 20a in a direction of an arrow F1 of FIG. 5 and simultaneously the ram 1 is pushed downward in a direction of an arrow F2 by means of the hydrostatic bearing 30a which is on the side opposite to the extending direction.

By this, a position of a tip of the ram 1 changes onto a center axis of the ram 1 in a non-deflection state as indicated by an arrow S in FIG. 5, thereby maintaining the straightness of the ram 1 in the direction of the main shaft unit 15.

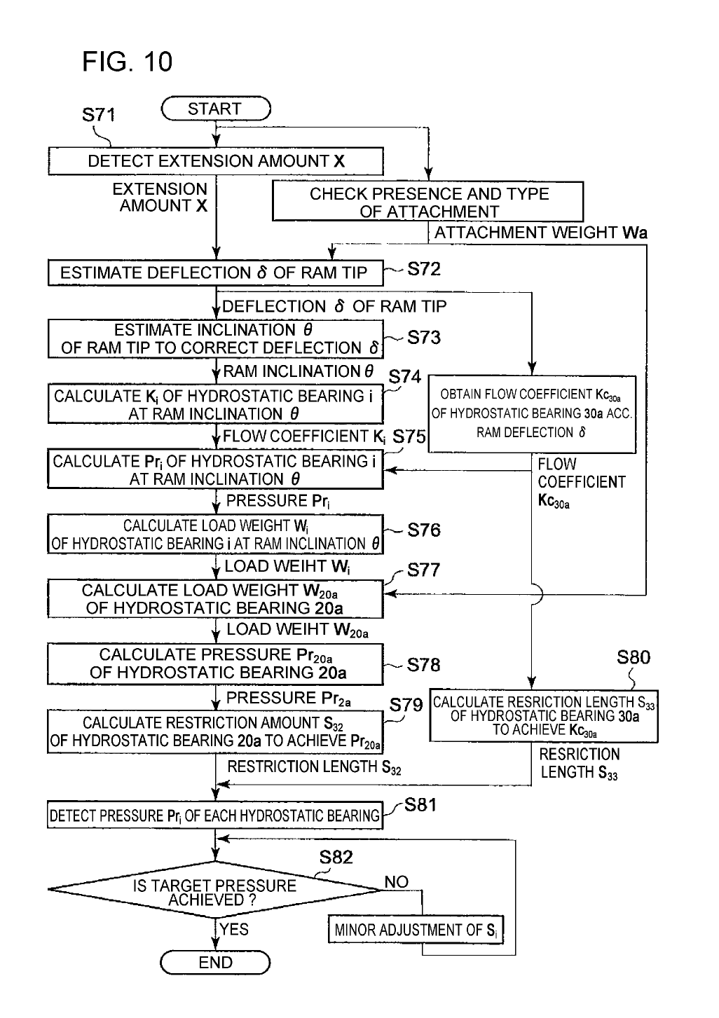

In order to maintain the straightness of the ram 1 in the direction of the main shaft is, the controller 10 performs a control to increase the hydraulic pressures Pr₂₀ₐ and Pr₃₀ₐ of the hydrostatic bearings 20a and 30a in accordance with the vertical displacement of the ram 1, i.e. the deflection δ, thereby correcting the a misalignment of the main shaft unit 15 by the inclination angle θ of the ram 1 caused by the increased hydraulic pressures Pr₂₀ₐ and Pr₃₀ₐ as shown in FIG. 10.

FIG. 10 is a flow chart of a control unit for correcting a position of the main shaft unit.

In FIG. 10, a flow coefficient Kc₃₀ₐ of the variable restricting device 33 of the hydrostatic bearing 30a is calculated from a database obtained beforehand in accordance with the amount of deflection δ of the tip of the ram 1 calculated in a step S72.

The flow coefficient Kc₃₀ₐ of the variable restricting device 33 is used in the formula for the pressure Prᵢ in a step S75 and also to calculate the adjustment amount of restriction S₃₃ of the restriction amount in a step S80.

After the step S80 of FIG. 10, the hydraulic pressure of each of the hydrostatic bearing is detected by the pressure sensor 37, 38, 39, 40 in a step S81. Next, in a step S82, it is determined if the pressure Prᵢ is at the target pressure. If the pressure Prᵢ is not at the target pressure, the restriction amount of each variable restriction device is adjusted.

The rest is substantially the same as that of the fourth embodiment.

According to the correction method performed by the controller 10, the misalignment of the main shaft unit 15 is corrected by performing the feedback control of the measured pressure of each hydrostatic bearing detected by the hydraulic pressure sensor 37, 38, 39, 40 so as to maintain the straightness of the ram 1 in the direction of the main shaft 1s. As a result, the misalignment of the main shaft unit 15 can be corrected with high precision.

It is, of course, possible to combine the inclination correction of the saddle 13 with respect to the column 14 in relation to the first and second embodiments with the inclination correction of the ram 1 with respect to the saddle 13 in relation to the third to fifth embodiments so as to overall control the inclination correction of the saddle 13 with respect to the column 14 and the inclination correction of the ram 1 with respect to the saddle 13.

### INDUSTRIAL APPLICABILITY

According to the present invention, it is now possible to provide a machining tool provided with a ram, which has a simple structure and an inexpensive device cost, and is capable of correcting a deflection of a tip of a main shaft unit caused by extending the ram.

1. A deflection correction device for a ram in a machining tool which is provided with a saddle moving vertically along a guide of a column and the rain housing a main shaft unit and being fitted in the saddle slidably in a horizontal direction, the device comprising:
a plurality of hydrostatic bearings via which the saddle is supported by the column in a longitudinal direction of the column; and
a control unit which controls a hydraulic pressure of the hydrostatic bearing in accordance with a vertical displacement of the ram to maintain a straightness of the ram in a direction of a main shaft of the ram so as to correct a misalignment of the main shaft unit by an inclination of the saddle caused by controlling the hydraulic pressure.

2. The deflection correction device for the ram according to claim 1,
wherein the control unit controls a hydraulic pressure of one of the plurality of the hydrostatic bearings supporting the saddle in the longitudinal direction of the column so as to maintain the straightness of the ram in the direction of the main shaft of the ram, the one of the hydrostatic bearings being in an extending direction of the ram and below the main shaft of the main shaft unit.

3. The deflection correction device for the ram according to claim 2,
wherein the control unit controls a hydraulic pressure of another of the hydrostatic bearings in addition to the one of the hydrostatic bearings which is arranged in the extending direction of the ram and below the main shaft of the main shaft unit so as to maintain the straightness of the ram in the direction of the main shaft of the ram, the another of the hydrostatic bearings being arranged symmetrically to the one of the hydrostatic bearings with respect to an intersection of the main shaft of the main shaft unit and a center line of the column that run at right angles to each other.

4. A deflection correction device for a ram in a machining tool which is provided with a saddle moving vertically along a guide of a column and the ram housing a main shaft unit and being fitted in the saddle slidably in a horizontal direction, the device comprising:
a plurality of hydrostatic bearings via which the ram is supported by the saddle in a longitudinal direction of the ram; and
a control unit which controls a hydraulic pressure of the hydrostatic bearing in accordance with a vertical displacement of the ram to maintain a straightness of the ram in a direction of a main shaft of the ram so as to correct a misalignment of the main shaft unit by an inclination of the saddle caused by controlling the hydraulic pressure.

5. The deflection correction device for the ram according to claim 4,
wherein the control unit controls a hydraulic pressure of one of the plurality of the hydrostatic bearings supporting the ram to the saddle so as to maintain the straightness of the ram in the direction of the main shaft of the ram, the one of the hydrostatic bearings being arranged in an extending direction of the ram and below a main shaft of the main shaft unit.

6. The deflection correction device for the ram according to claim 5,
wherein the control unit controls a hydraulic pressure of another of the hydrostatic bearings in addition to the one of the hydrostatic bearings which is arranged in the extending direction of the ram and below the main shaft of the main shaft unit so as to maintain the straightness of the ram in the direction of the main shaft of the ram, the another of the hydrostatic bearings being arranged symmetrically to the one of the hydrostatic bearings with respect to an intersection of the main shaft of the main shaft unit and a center line of the saddle that run at right angles to each other.

7. The deflection correction device for the ram according to claim 1, further comprising:
a restricting device which regulates an amount of oil supplied to the hydrostatic bearing; and
a hydraulic pressure sensor which measures the hydraulic pressure of the oil supplied to each of the hydrostatic bearings,
wherein the control unit controls a restriction amount of the restricting device so that the hydraulic pressure becomes a target hydraulic pressure of the hydrostatic bearing based on a hydraulic pressure detected by the hydraulic pressure sensor.

8. The deflection correction device for the ram according to claim 1, further comprising:
a restricting device which regulates an amount of oil supplied to the hydrostatic bearing,
wherein the control unit controls a restriction amount of the restricting device so that the restriction amount of the restricting device becomes a target restriction amount which is calculated to achieve a target hydraulic pressure of the hydrostatic bearing.

9. The deflection correction device for the ram according to claim 4, further comprising:
a restricting device which regulates an amount of oil supplied to the hydrostatic bearing; and
a hydraulic pressure sensor which measures the hydraulic pressure of the oil supplied to each of the hydrostatic bearings,
wherein the control unit controls a restriction amount of the restricting device so that the hydraulic pressure becomes a target hydraulic pressure of the hydrostatic bearing based on a hydraulic pressure detected by the hydraulic pressure sensor.

10. The deflection correction device for the ram according to claim 4, further comprising:
a restricting device which regulates an amount of oil supplied to the hydrostatic bearing,
wherein the control unit controls a restriction amount of the restricting device so that the restriction amount of the restricting device becomes a target restriction amount which is calculated to achieve a target hydraulic pressure of the hydrostatic bearing.
